(19) United States
(12) Patent Application Publication
(10) Pub. No.: US 2017/0054750 A1
(43) Pub. Date: Feb. 23, 2017

(54) RISK ASSESSMENT

(71) Applicant: HEWLETT PACKARD ENTERPRISE DEVELOPMENT LP, Houston, TX (US)

(72) Inventor: Jeremy Philip Ward, Bracknell (GB)

(21) Appl. No.: 15/119,423

(22) PCT Filed: Feb. 18, 2014
(86) PCT No.: PCT/US2014/016780

§ 371 Date: Aug. 17, 2016

(51) Int. Cl. H04L 29/06; G06F 17/30

(52) U.S. Cl. CPC H04L 63/1433; H04L 63/1425; G06F 17/30867; G06F 17/30994

(57) ABSTRACT

A method is provided in accordance with an aspect of the present disclosure. The method includes processing data related to a plurality of security risk metrics for an entity and identifying a change in at least one of the security risk metrics. The security risk metrics are associated with risk component data. The method also includes defining determining modifications in risk assessment data that is associated with the risk component data based on the change in the at least one of the security risk metrics, and displaying information about the risk assessment data and the risk component data.

### BACKGROUND

Information security is the practice of defending information in an entity (e.g., organization, business, etc.) from unauthorized access, use, disclosure, disruption, modification, perusal, recording, destruction, or any other type of unauthorized use. Effective management of information security risk is an important task for all entities. Mitigating and/or eliminating information security issues helps these entities to achieve their goals efficiently and with minimal loss of time and/or profit. However, in many situations, managing information security risk by an entity is a difficult and an expensive task.

### BRIEF DESCRIPTION OF THE DRAWINGS

FIG. 1 is a schematic illustration of an example of a system for managing information security risk in an entity in accordance with an implementation of the present disclosure.

FIG. 2 illustrates a flow chart showing an example of a method for managing information security risk in an entity in accordance with an implementation of the present disclosure.

FIG. 3 illustrates a table showing an example list of security risk metrics associated with a risk component threat category in accordance with an implementation of the present disclosure.

FIGS. 4A and 4B illustrate a flow chart showing an example of a method for linking risk component data to risk assessment data in accordance with an implementation of the present disclosure.

FIG. 5 shows an example of a table illustrating a comparison of a plurality of business objectives for an entity in accordance with an implementation of the present disclosure.

FIG. 6 shows an example of a table that illustrates prioritizing a plurality of business objectives by using a ranking score in accordance with an implementation of the present disclosure.

FIG. 7 shows an example of a table illustrating a comparison between a plurality of business objectives and a plurality of business processes for an entity in accordance with an implementation of the present disclosure.

FIG. 8 illustrates a flow chart showing an example of an alternative method for managing information security risk in an entity in accordance with an implementation of the present disclosure.

FIG. 9 shows an example of a graphical representation illustrating incident alert information and risk trend information for a plurality of business objectives in accordance with an implementation of the present disclosure.

FIG. 10 shows an example of a graphical representation illustrating risk assessment data and the risk component data for an entity in accordance with an implementation of the present disclosure.

### DETAILED DESCRIPTION

As mentioned above, entities always look for ways to effectively manage information security risk. A major issue associated with information security management is the difficulty of measuring information security risk. Generally, this is not due to a lack of relevant information security data. Various information security systems (e.g., firewalls, intrusion detection systems, etc.) produce such information security data in abundance. In some respects, it is the abundance of this information security data that makes measurement information security risk difficult.

As used herein, the term “information security risk” refers to a potential that a given threat related to information security may exploit vulnerabilities of an asset or group of assets (e.g., information assets) in an entity and, thereby, cause a harmful incident to the entity. As used herein, the term “threat” refers to a potential cause of an incident that may result in harm to at least one of the entity's asset; the term “vulnerability” refers to a security weakness that potentially enables a threat to cause harm to at least one asset; and the term “incident” refers to a single or a series of unwanted or unexpected information security events that have a significant probability of causing harm to at least one asset.

Different systems may be used to examine large volumes of information security data for an entity in order to identify security events and incidents. However, the reporting data generated by these systems is intended primarily for the use of specialists involved in the analysis of information security operations (e.g., trained information security analysts, helpdesk or IT professionals, etc.). The reports created by these systems generally include different metrics related to the performance of various technologies of the entity and may be only be used by information security analysts. These reports do not deliver meaningful risk indicators to members of the entity outside security and IT functions, such as members that support implementation of the business objectives of the entity (also called stakeholders.). As used herein, the term “stakeholders” refers to individuals within an entity who have an interest in ensuring that information security risk management is effective in supporting the business objectives of the entity.

However, effective management of information security risk requires close cooperation and understanding between different members and groups of stakeholders throughout an entity (e.g., executives, risk management members, human resources, legal, IT/security, etc.). Managing the security risk for an entity must be coordinated with members of all levels within that entity in order to better evaluate the potential risks and consequences of information security breaches. Thus, it is important to communicate information about security risk to each stakeholder group by showing the effect of that security risk on the stakeholders' business objectives.

Therefore, there is a need for simple and efficient risk assessment and information security management tools. Such tools should not require sophisticated understanding of risk analysis and should be designed to be used and understood by any stakeholder group in an entity. If these risk assessment and information security management tools are very complex and/or require excessive training, entities will be unable or unwilling to invest resources to maintain such tools. Alternatively, in the absence of such efficient tools, large entities may turn to consultancy services to design information security systems that are tailored to their individual needs. However, in the absence of a clear framework within which security metrics can be understood and reported, the delivered results may lack direction and clarity. In addition, such projects are lengthy, complex and expensive; with uncertain outcomes that fall short of the client's requirements.

The present description is directed to systems, methods, and computer readable media for effective management of information security risk in an entity. Specifically, the present description proposes an approach for quantifiably assessing information security data in an entity and assisting managing security risk by communicating its potential to affect specific business objectives of stakeholders throughout the entity. Thus, the proposed description enables timely, effective and efficient management of risk to the business operations of the entity.

In particular, the disclosed systems, methods, and computer readable media enable an entity to prioritize the business objectives of specified stakeholder groups and link them to a set of business processes which support those objectives. The proposed systems, methods, and computer readable media then link these business processes to groups of information assets that support the business processes. Thus, a quantitative link between stakeholders' business objectives and the entity's information assets is produced. In order to indicate risk to the information assets, the proposed systems, methods, and computer readable media identify significant links between risk component data (e.g., threats, vulnerabilities, and incidents) for the entity and the information assets.

To collect the appropriate risk component data, the proposed description uses structured sets of security risk metrics that are used to collect data from the entity's security technology and processes. With the established links between the risk component data and the entity's information assets, business processes, and business objectives (also called risk assessment data), the proposed systems, methods, and computer readable media communicate security accidents and risk status in a relevant way to the different stakeholder groups. Thus, the stakeholder groups can see through their own point of view how changes in risk component data potentially affect the risk status of their business objectives.

As used herein, the term “business objectives” refers to the aims or goals that contribute to the overall business strategy of an entity. In the context of this description, business objectives are determined by stakeholders; selected with reference to the role and responsibilities of the stakeholder within the entity; and are prioritized in relation to the importance of each business objective to the entity's overall business strategy. Example types of business objectives for an entity may include: executive objectives, managerial objectives, compliance objectives, tactical objectives, etc. Specific business objectives may include: shareholder value, customer retention, managing cost, etc.

As used herein, the term “business processes” refers to different functional activities that support business objectives in an entity. Business processes are selected on the basis of their ability to support an individual stakeholder's business objectives; and their significance to each of those business objectives is determined accordingly. Business processes may include: research and development, supply chain management, finance and administration, etc.

As used herein, the term “information assets” refers to any information-related technology, system, process, or resource that has value to the entity in helping to achieve its overall business strategy. In the context of this disclosure, information assets are functional groups of such technologies, people, and practices that are selected on the basis of their ability to support an individual stakeholder's business processes; and their significance to each of those business processes is determined. Information assets may include: customer databases, supplier databases, communication systems, security systems; etc. As used herein, the term “security risk metrics” refers to information security data collected from the entity's security technology and processes that is associated with the risk component data. The security risk metrics are used to determine whether there is a change in the risk component data that may affect the entity's risk assessment data (e.g., information assets, business processes, and business objectives) for the entity.

Therefore, the proposed solution overcomes the problem of communicating meaningful risk assessments to all stakeholders of an entity by using a simple, clear framework to link stakeholders' business objectives, processes, and assets to data gathered about threats, vulnerabilities and incidents. As described in additional details below, the described processes enable the proposed solution to be repeated for any number of stakeholders, or groups of stakeholders. The business objectives and linkages can be re-assessed at intervals determined by the stakeholders. Thus, the proposed solution quantifiably and appropriately communicates information security data in a way that enables timely, effective, and efficient decisions to be made about the management of information security risk, as it affects the business objectives of different stakeholders through an entity.

In addition, the proposed solution does not require complex or sophisticated understanding of risk assessment. The proposed techniques use a simple stepwise process to assess the significance or business processes to business objectives and of information assets to business processes. The significance of the risk component data (e.g., threats, vulnerabilities, and incidents) to the information assets is assessed specifically for each entity. The solution is intended to be clear to any stakeholder who is able to follow the mechanism by which risk alerts are produced and to drill down into the reason for their production.

Thus, the proposed solution is designed to enable stakeholders in an entity to manage information security risk for that entity by providing up-to-the-minute, dynamic information to assist the business decision making process. The solution offers processes for correlation, analysis and display of potential and actual risks to the business objectives of entity's key stakeholders. The solution allows entities to be accountable for their security actions, to report security progress to the business, and to help manage risk effectively. Further, the solution allows entities to evaluate exposure and mitigate any damage, to demonstrate regulatory compliance, to provide better stewardship and justify security spending, and to improve security awareness among all members of the entity.

In the following detailed description, reference is made to the accompanying drawings, which form a part hereof, and in which is shown by way of illustration specific examples in which the disclosed subject matter may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. It should also be noted that a plurality of hardware and software based devices, as well as a plurality of different structural components may be used to implement the disclosed methods and systems.

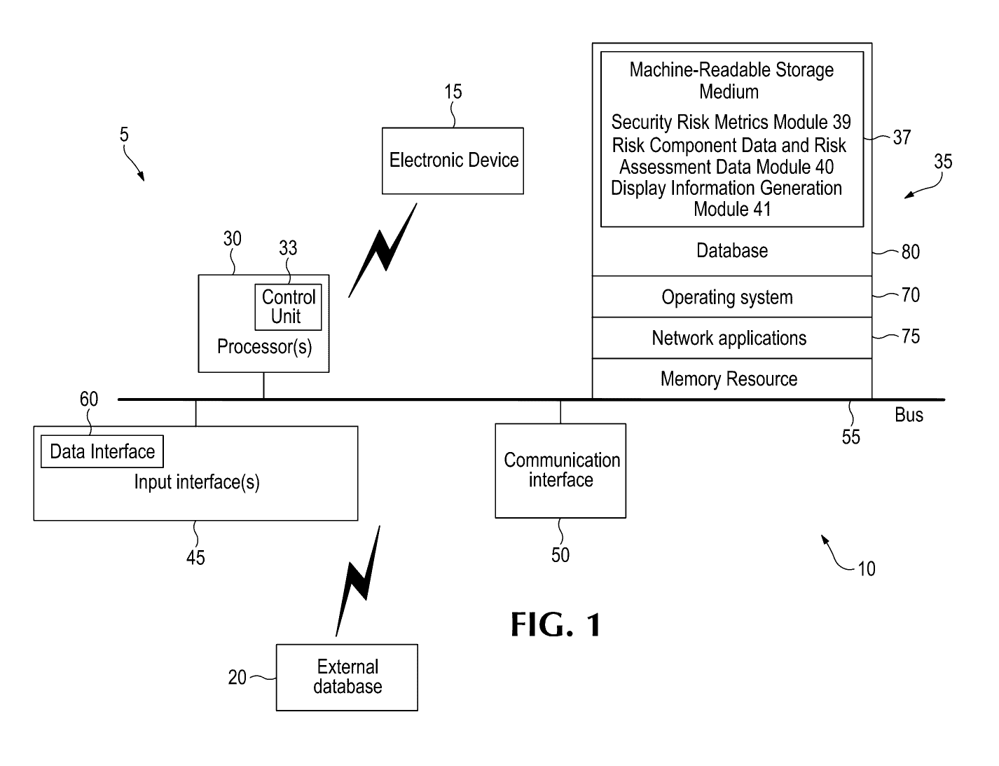

FIG. 1 is a schematic illustration of an example of a system 5 for managing information security risk in an entity. The system 5 includes at least one computing device 10 capable of carrying out the techniques described below. The computing device 10 can be a personal computer, a laptop, a server, a mobile device, a plurality of distributed computing devices, or any other suitable computing device. As explained in additional details below, the computing device 10 may be a device operated by an entity or a device operated by a third party that offers service to the entity. In the illustrated example, the computing device 10 includes at least one processing device 30 (also called a processor), a memory resource 35, input interface(s) 45, and communication interface 50. In other examples, the computing device 10 includes additional, fewer, or different components for carrying out the functionality described herein.

As explained in additional detail below, the computing device 10 includes software, hardware, or a suitable combination thereof configured to enable functionality of the computing device 10 and to allow it to carry the techniques described below and to interact with the one or more external systems/devices. For example, the computing device 10 includes communication interfaces (e.g., a Wi-Fi® interface, a Bluetooth® interface, a 3G interface, a 4G interface, a near filed communication (NFC) interface, etc.) that are used to connect with external devices/systems and/or to a network (not shown). The network may include any suitable type or configuration of network to allow for communication between the computing device 10 and any external devices/systems.

For example, the computing device 10 can communicate with at least one external electronic device 15 (e.g., a computing device, a server, a plurality of distributed computing devices, etc.) or with an external database 20 to receive input data related to a plurality of security risks metrics for an entity. It is to be understood that the operations described as being performed by the computing device 10 that are related to this description may, in some implementations, be performed or distributed between the computing device 10 and other computing devices (not shown).

The processing device 30 of the computing device 10 (e.g., a central processing unit, a group of distributed processors, a microprocessor, a microcontroller, an application-specific integrated circuit (ASIC), a graphics processor, a multiprocessor, a virtual processor, a cloud processing system, or another suitable controller or programmable device), the memory resource 35, the input interfaces 45, and the communication interface 50 are operatively coupled to a bus 55.

The communication interface 50 allows the computing device 10 to communicate with plurality of networks, communication links, and external devices. The input interfaces 45 can receive information from any internal or external devices/systems in communication with the computing device 10. In one example, the input interfaces 45 include at least a data interface 60. In other examples, the input interfaces 45 can include additional interfaces. In one implementation, the data interface 60 receives communications from the electronic device 15, the external database 20, or other external devices. The communications may include information related a plurality of security risks metrics for at least one entity. In some examples, that information may be extracted from entity's security technology and processes and sent to the computing device 10. Alternatively, the computing device 10 may access security risks metrics data by directly communicating with different external systems and/or devices.

The processor 30 includes a controller 33 (also called a control unit) and may be implemented using any suitable type of processing system where at least one processor executes computer-readable instructions stored in the memory 35. The memory resource 35 includes any suitable type, number, and configuration of volatile or non-transitory machine-readable storage media 37 to store instructions and data. Examples of machine-readable storage media 37 in the memory 35 include read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, an SD card, and other suitable magnetic, optical, physical, or electronic memory devices. The memory resource 35 may also be used for storing temporary variables or other intermediate information during execution of instructions to by the processor 30.

The memory 35 may also store an operating system 70 and network applications 75. The operating system 70 can be multi-user, multiprocessing, multitasking, multithreading, and real-time. The operating system 70 can also perform basic tasks such as recognizing input from input devices, such as a keyboard, a keypad, a mouse; sending output to a projector and a camera; keeping track of files and directories on memory 35; controlling peripheral devices, such as printers, image capture device; and managing traffic on the bus 55. The network applications 75 include various components for establishing and maintaining network connections, such as computer-readable instructions for implementing communication protocols including TCP/IP, HTTP, Ethernet®, USB®, and FireWire®.

Software stored on the non-transitory machine-readable storage media 37 and executed by the processor 30 includes, for example, firmware, applications, program data, filters, rules, program modules, and other executable instructions. The control unit 33 retrieves from the machine-readable storage media 37 and executes, among other things, instructions related to the control processes and methods described herein. In one example, the instructions stored in the non-transitory machine-readable storage media 37 implement a security risk metrics module 39, a risk component data and risk assessment data module 40, and a display information generation module 41. In other examples, the instructions can implement more or fewer modules (e.g., various other modules related to the operation of the system 5). In one example, modules 39-41 may be implemented with electronic circuitry used to carry out the functionality described below. As mentioned above, in addition or as an alternative, modules 39-41 may be implemented as a series of instructions encoded on a machine-readable storage medium and executable by a processor.

As explained in additional detail below, the security risk metrics module 39 receives and processes different data related to a plurality of security risk metrics for an entity. The risk component data and risk assessment data module 40 links risk component data to risk assessment data and analyzes the data to identify a change in at least one of the security risk metrics associated with the risk component data. The module 40 also determines modifications in the risk assessment data based on the change in the at least one of the security risk metrics. The display information generation module 41 generates and displays information (e.g., incident alert, risk trend, etc.) to a stakeholder about the risk assessment data and the risk component data in the entity based on a change in the security risk metrics.

Information associated with the system 5 and other systems/devices can be stored, logged, processed, and analyzed to implement the control methods and processes described herein. For example, the memory 35 may include at least one database 80. In other example implementations, the system 5 may access external database (e.g., database 20) that may be stored remotely of the computing device 10 (e.g., can be accessed via a network or a cloud). The database 80 or the external database 20 may store various information related to the risk assessment data and the risk component data for an entity.

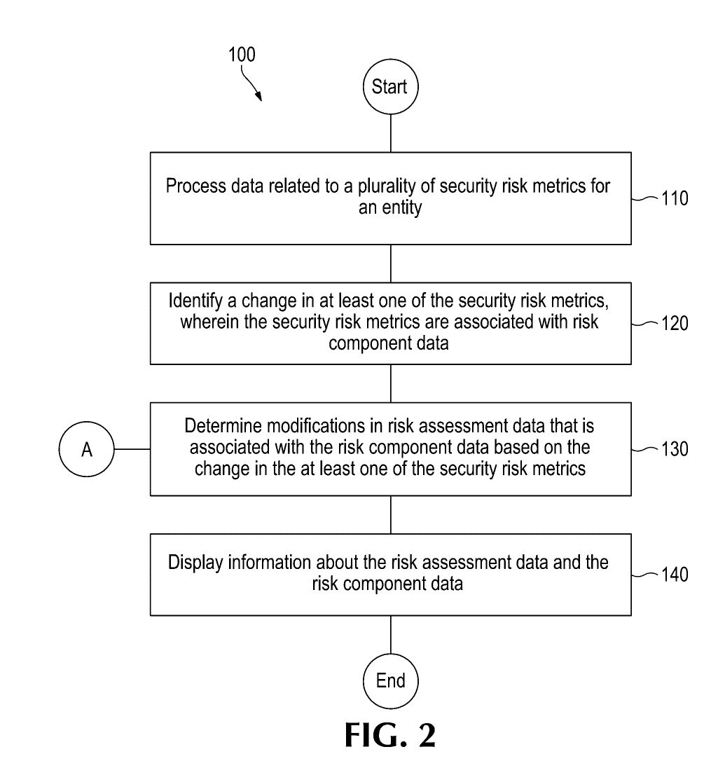

FIG. 2 illustrates a flow chart showing an example of a method 100 for managing information security risk in an entity. In one example, the method 100 can be executed by the control unit 33 of the processor 30 of the computing device 10. Various elements or blocks described herein with respect to the method 100 are capable of being executed simultaneously, in parallel, or in an order that differs from the illustrated serial manner of execution. The method 100 is also capable of being executed using additional or fewer elements than are shown in the illustrated examples.

The method 100 may be executed in the form of instructions encoded on a non-transitory machine-readable storage medium 37 executable by the processor 30 of the computing device 10. In one example, the instructions for the method 100 implement the security risk metrics module 39, the risk component data and risk assessment data module 40, and the display information generation module 41. In other examples, the execution of the method 100 may be distributed between the processing device 30 and other processing devices in communication with the processing device 30. In some example implementations, the computing device 10 may be a device of an entity and may be operated by the entity. Alternatively, the computing device 10 may be operated by a third party that offers service to an entity in order to assist the entity with managing information security risk.

The method 100 begins at block 110, where the processor 30 processes data related to a plurality of security risk metrics for an entity. This may be performed by the security risk metrics module 39. The security risk metrics represent information security data for the entity and are associated with risk component data (e.g., threats, vulnerabilities, and incidents) for the entity. The data related to the plurality of security risk may be collected or extracted from any the entity's technologies and processes that produce data relevant to security, such as anti-virus systems, access control systems, configuration management databases, etc. That security risk metrics data may be collected or extracted immediately before it is processed, or it may be stored on the database 80 and repetitively updated before processing. For example, each entity may specify what type of security risk metrics are to be monitored in relation to each risk component data category, the origin of the data, the sampling rate of gathering, the dependencies of the data, etc. As explained in additional details below, the security risk metrics are associated with risk component data (e.g., threats, vulnerabilities, and incidents).

When the described process is offered as a third party service to the entity, the third party may provide a list of security risk metrics to be selected by the entity based on analysis of the entity's security technology and processes. Tailoring the proposed process for an entity may depend largely of determining what data can be gathered from the entity's existing security technologies and processes and establishing appropriate connectors for that data. Alternatively, security risk metrics may be defined in a predetermined generic catalogue that may be used by any entity. Such generic catalogue may be fully designated within a clear framework of predetermined number of risk component categories (e.g., threats, vulnerabilities, and incidents). In other words, the third party may specify a list of risk component categories, where each of the members of that list is associated with specific security risk metrics. Therefore, there may be no need to determine individual security risk metrics for each new entity implementing the described process.

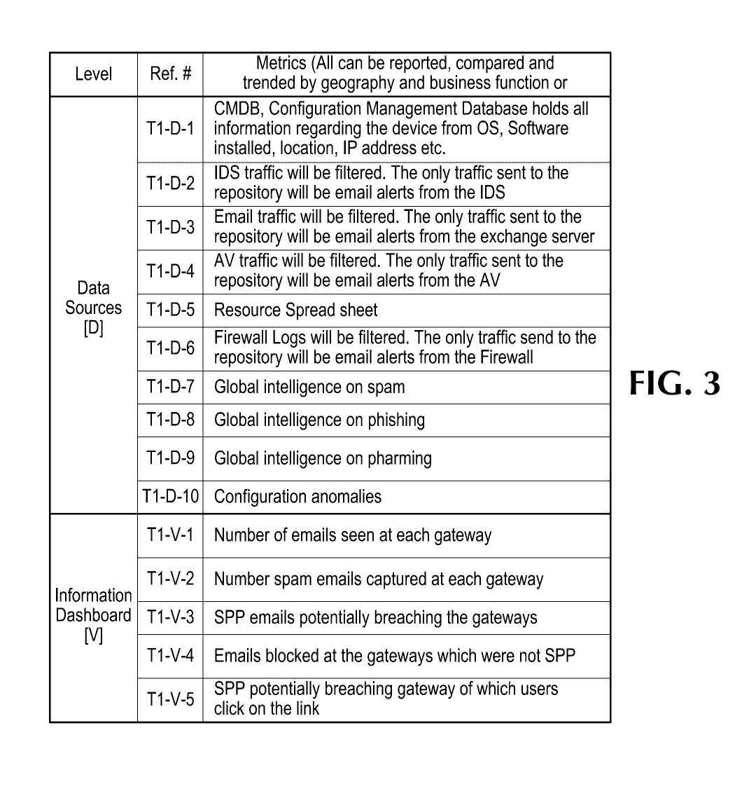

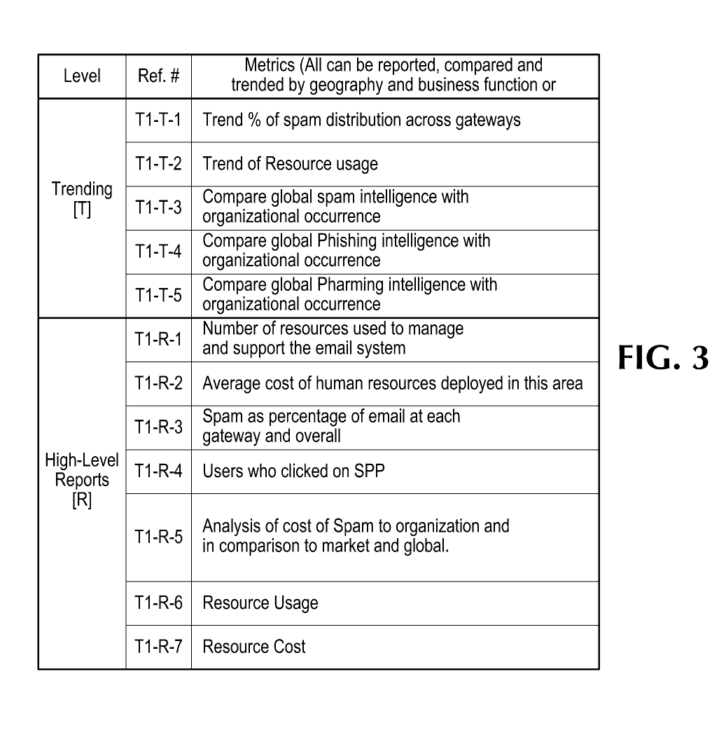

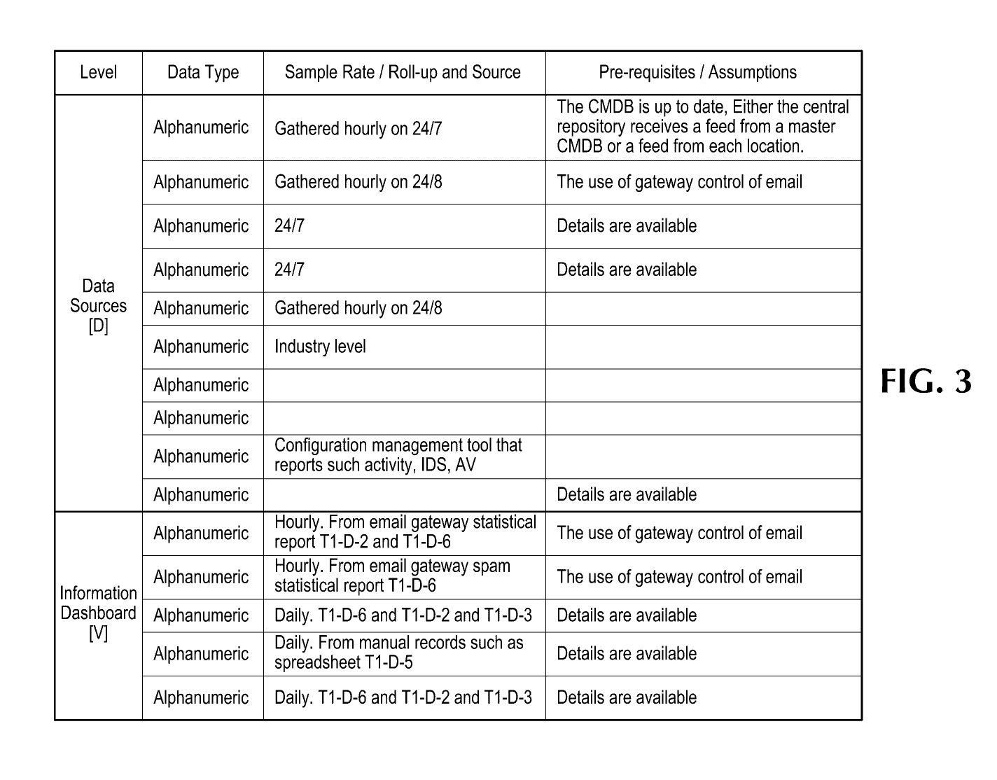

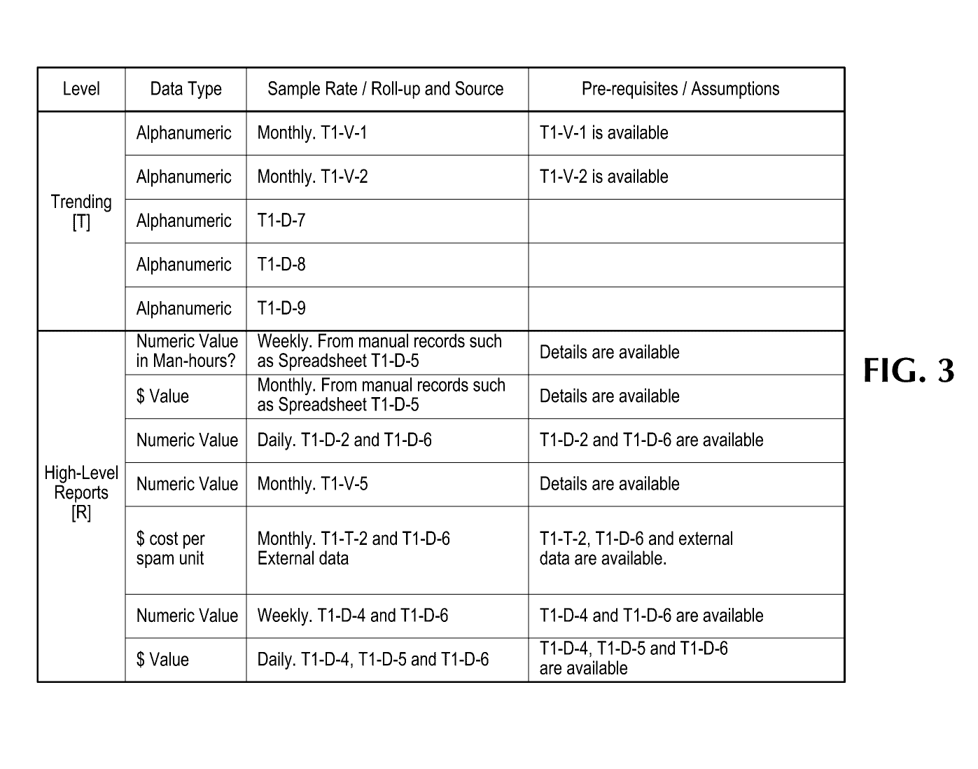

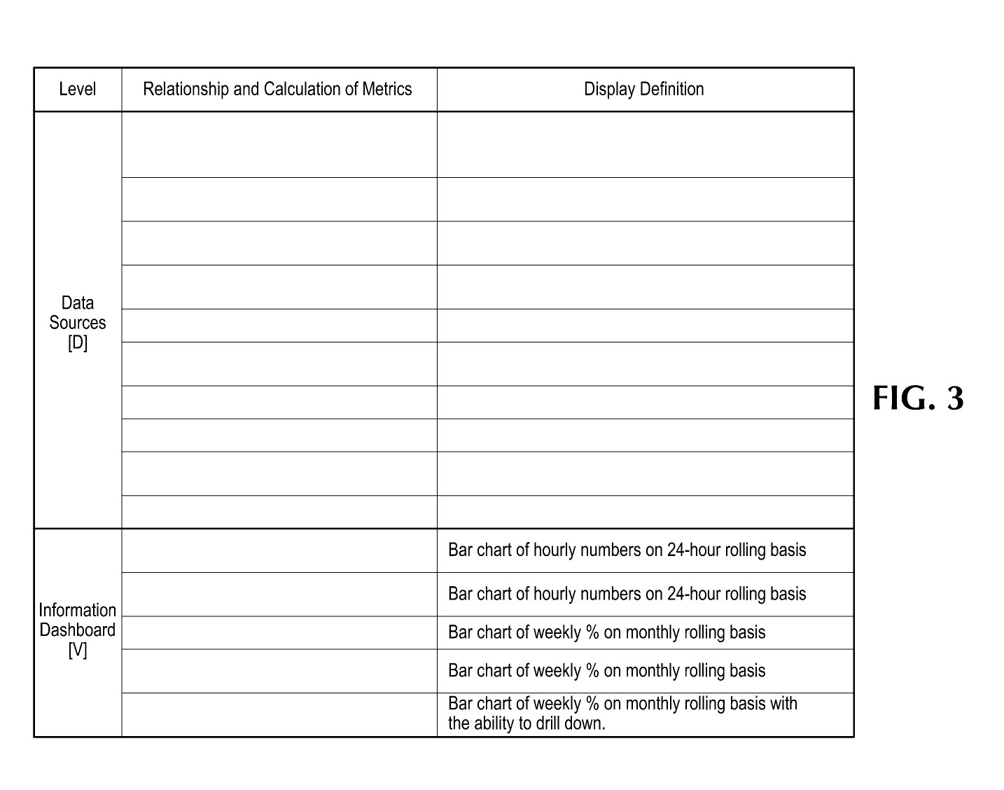

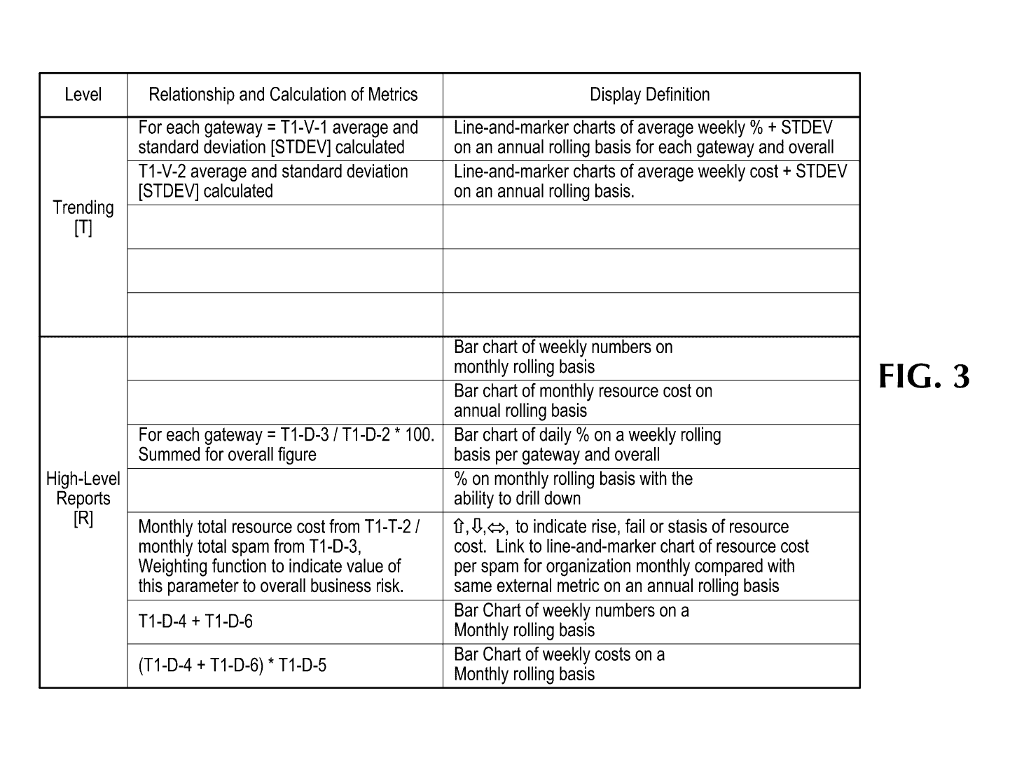

FIG. 3 illustrates a table showing an example list of security risk metrics associated with a single risk component threat category—“spam, phishing, and pharming.” Each of the components or elements of the risk component data (i.e., each of the identified threats, vulnerabilities, and incidents) is associated with at least one (or a plurality) of security risk metrics. The security risk metrics may differ depending on the type of risk component data, the type of entity, the operations performed by the entity, and other relevant factors. In addition to specifying the potential sources of security risk metrics data, several levels for the display of security risk metrics for all risk component categories may be defined. These display levels may specify how security risk metrics should be displayed as gathered in a dashboard, how they should be displayed to indicate trends, and how they may be combined to deliver other information relevant to the management of security risk, such as the cost effectiveness of resources used.

As shown in FIG. 3, security risk metrics for the “spam, phishing, and pharming” risk component threat category may include: global intelligence on spam; global intelligence on pharming; number of emails seen at each gateway; number of spam emails captured at each gateway; trend of resource usage; spam as percentage of email at each gateway and overall; etc. The data related to the plurality of security risk metrics includes: the data type of the security risk metrics (e.g., alphanumeric value, numeric value, monetary value, etc.); the sampling rate of gathering and the source of the data; prerequisites and assumptions related to the plurality of security risk metrics; relationships and calculation of the metrics; display information related to the metrics; etc. All this data may be customized by the entity and/or by the third party providing a service and may be edited at any time to add or remove security risk metrics information.

With continued reference to FIG. 1, the control unit 33 identifies a change in at least one of the security risk metrics associated with the risk component data (at 120). This may be performed by the risk component data and risk assessment data module 40. The risk component data includes security threats data, security vulnerabilities data, and security incidents data. In other examples, the risk component data may include other types of data. That data may be specific for each entity and may be modified by stakeholders in the entity. In other words, the control unit 33 periodically analyzes the data related to the plurality of security risk metrics of the entity to determine if at least security risk metrics exceed a threshold. For example, the “resource usage” metric in FIG. 3 is associated with the “spam, phishing, and pharming” threat component from the risk component data. A threshold may be set for that metric (or for any other metric) and the control unit 33 can monitor when the metric exceeds that threshold.

Since the security risk metrics are associated with the elements of the risk component data, a change in the at least one of the security risk metrics may indicate that there is a security issue related to the entity (e.g., threat, vulnerability, or incident). For example, a change in the “resource usage” metric indicates that there is a potential “spam, phishing, and pharming” threat for the entity. As explained in additional details below, because the risk component data is linked to the risk assessment data, the control unit can provide information about corresponding changes in the risk assessment data based on the change in the at least one of the security risk metrics.

In one example, the security threats data includes a plurality of threats related to the information security of the entity (e.g., spam pushing and pharming, malware, unauthorized access, abuse of access privilege, legal and regulatory threats, damage to hardware, loss of hardware, human error and social engineering, change, etc.). The security vulnerabilities data includes a plurality of vulnerabilities related to the information security of the entity (e.g., security and regulatory awareness, security organization and resources, supplier security, location security, process control, change control, data control, mobile device control, legacy system security, security architecture, etc.).

In addition, the security incidents data includes a plurality of incidents related to the information security of the entity (e.g., insider attack, malware attack, web-based attack, legal or regulatory action, physical damage or loss, website defacement, failed service management, email attack, adverse publicity, DDOs attack, etc.). It is to be understood that the risk component data may be different for different entities or general risk component data may be used for all entities. The risk component data may be defined and/or selected by each entity or may be selected by a third party when the described process is offered as a service. As mentioned above, each element in the risk component data is associated or linked with a plurality of security risk metrics.

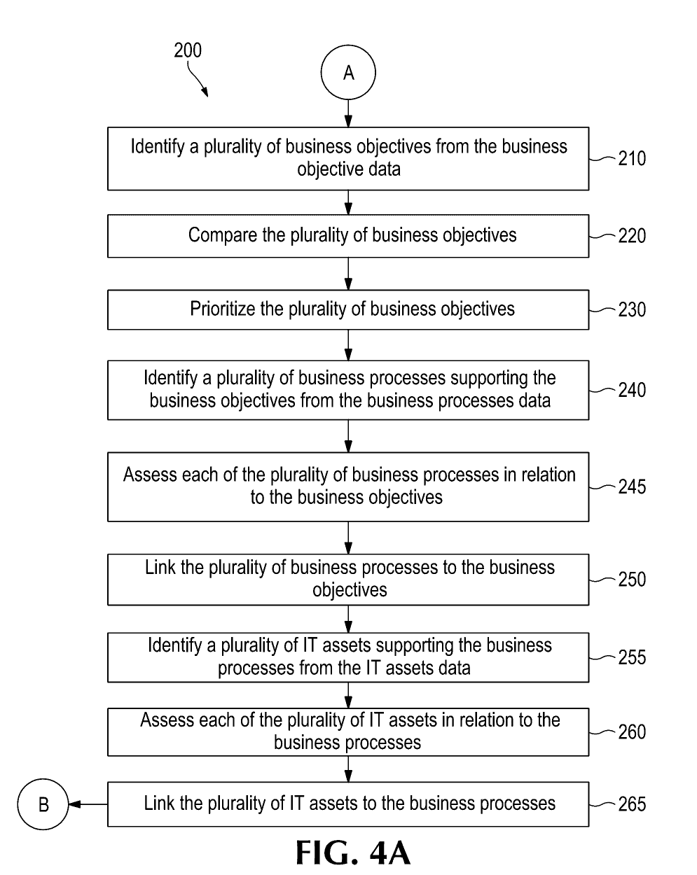

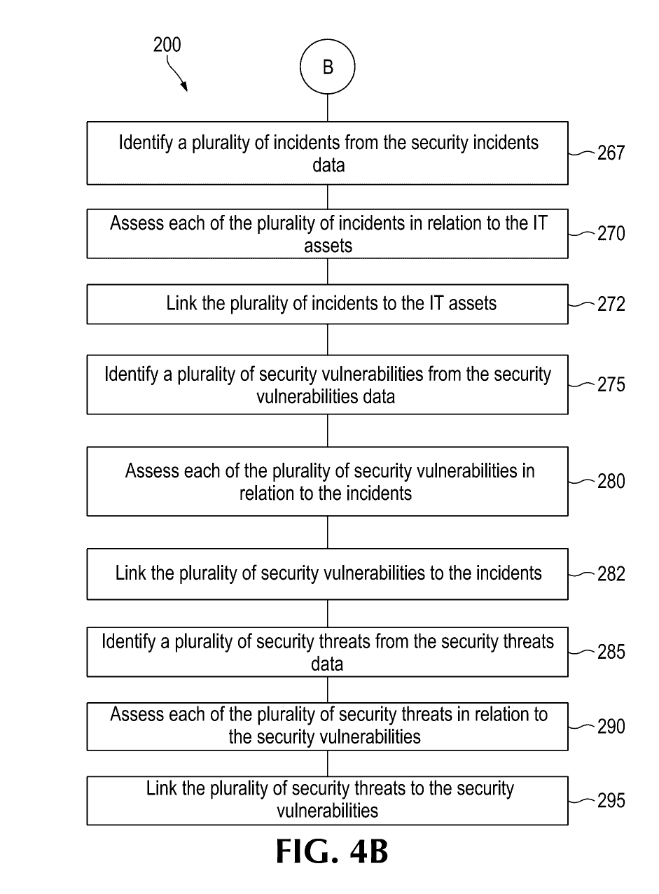

At 130, the control unit 33 determines modifications in the risk assessment data that is associated with the risk component data based on the change in the at least one of the security risk metrics. This may be performed by the risk component data and risk assessment data module 40. As explained in additional details below (see FIGS. 4A-4B), the risk component data is linked with the risk assessment data and that connection allows a user to manage the information risk in the entity by analyzing the broad effect which an information breach may have on the business of the entity. The risk assessment data includes business objectives data, business processes data, and information assets data (e.g., various business objectives, business processes, and information assets for the entity). In other examples, the risk assessment data may include other types of data.

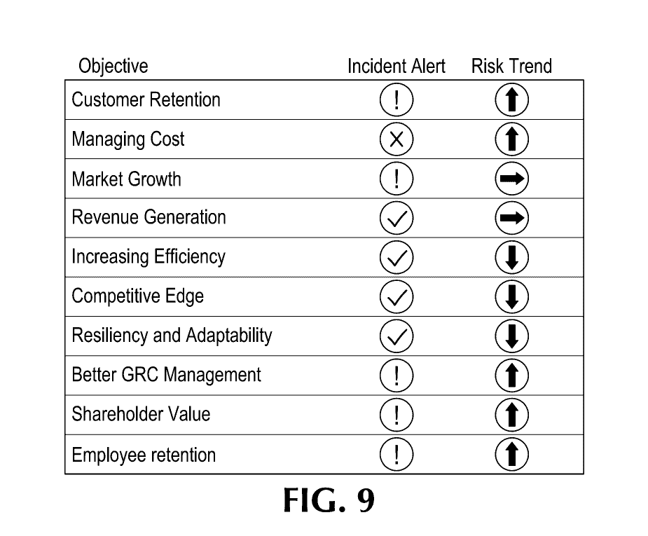

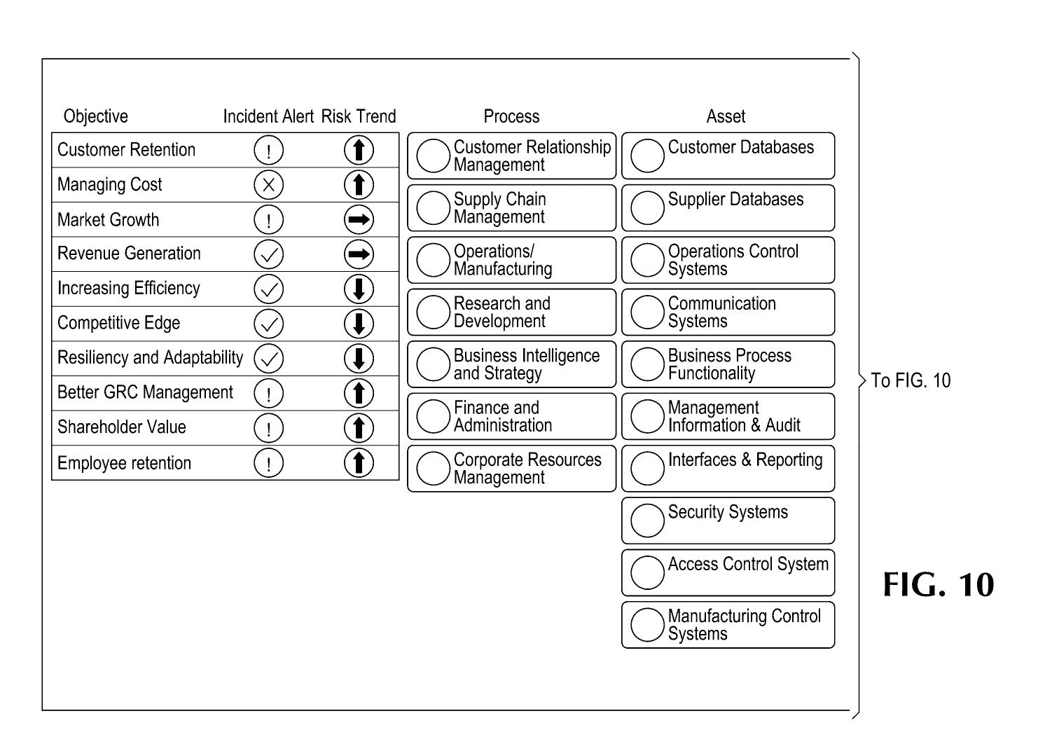

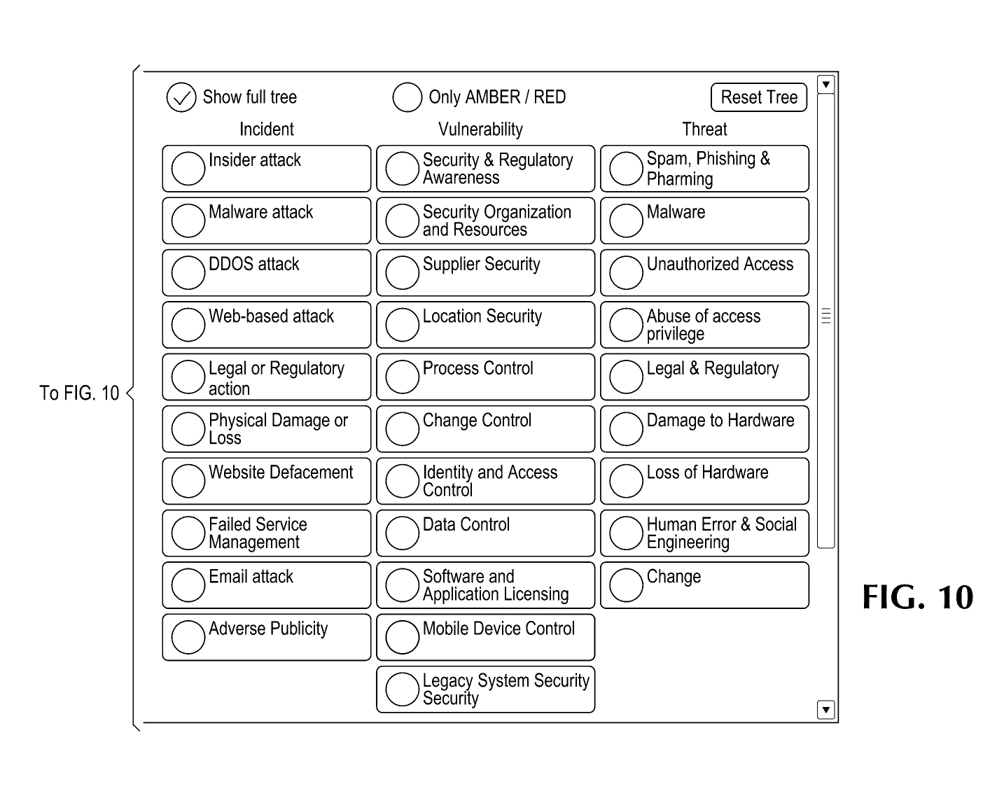

Changes in the risk component data may ultimately trigger a change in a visual risk indicator (i.e., a graphical representation indicator) associated with a business objective to which the risk component data may be linked by the way of information assets and business processes. In other words, the control unit may display information about the corresponding changes in the risk assessment data and the risk component data for the entity (at 140). This may be performed by the display information generation module 41 and examples are shown in FIGS. 9 and 10. As explained in additional details below, the displayed information may vary depending on the entity and the selected information preferences. Changes in a risk indicator associated with a business objective will alert stakeholders who can use the linkages defined by the system 5 to determine which risk component category has triggered the status change. Once the relevant risk component category has been identified, the stakeholders may drill down into the associated higher level information dashboard or data layers to investigate the exact cause of the risk indicator status (e.g., the specific metric(s) causing the change in the risk component data).

FIGS. 4A and 4B illustrate a method 200 for linking risk component data to risk assessment data. In one example, the method 200 can be executed by the control unit 33 of the processor 30. Various elements or blocks described herein with respect to the method 200 are capable of being executed simultaneously, in parallel, or in an order that differs from the illustrated serial manner of execution. The method 200 is also capable of being executed using additional or fewer elements than are shown in the illustrated examples. The method 200 may be executed in the form of instructions encoded on a non-transitory machine-readable storage medium 37 executable by the processor 30 of the computing device 10. In one example, the instructions for the method 200 implement the risk component data and risk assessment data module 40.

The method 200 begins at 210, where the control unit 33 identifies a plurality of business objectives from the business objectives data. In one example, business objectives may be selected by an individual stakeholder group in the entity. For instance, an executive level stakeholder group may identify “customer retention” and “market growth” business objectives, a managerial stakeholder group may identify “delivering cost effective solutions” and “improving service legal agreements” business objectives, etc. Alternatively, business objectives may be selected for the entire entity and all stakeholder groups. Other examples of business objectives may include: shareholder value, revenue generation, increasing efficiency, competitive edge, managing cost, resiliency and adaptability, employee retention, etc. The business objectives may be manually entered or may be selected from a group of predetermined business objectives available to the entity (i.e., when the process is offered a third party service).

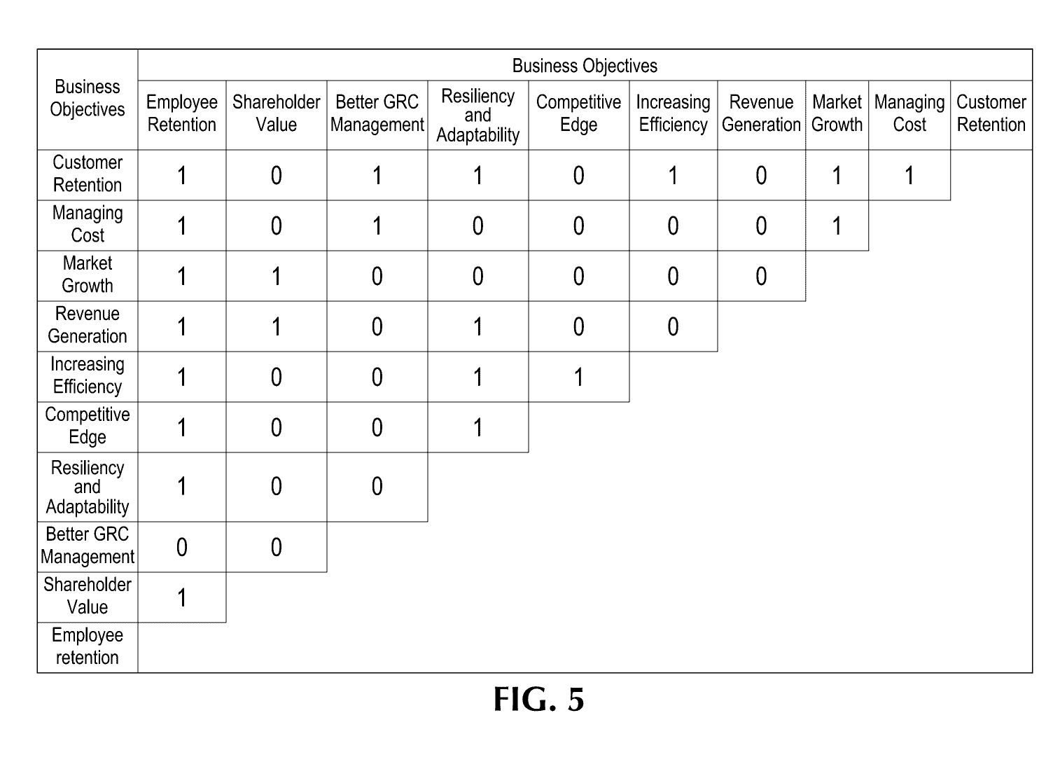

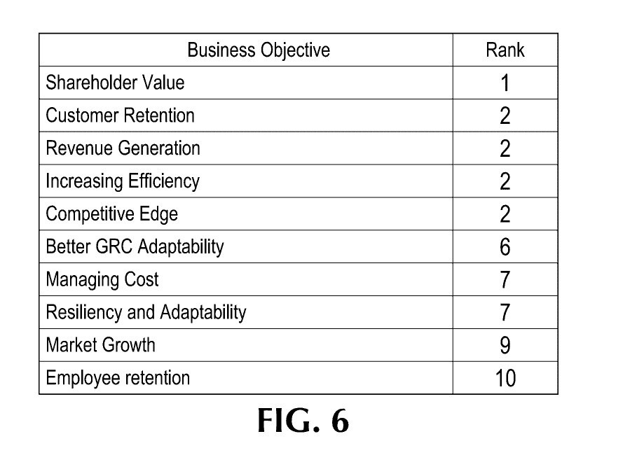

Next, at 220, the control unit 33 receives an input to compare the plurality of business objectives. In one example, the control unit may generate a table with the identified business objectives, where each business objective is displayed in the x-axis and in the in y-axis of the table. FIG. 5 shows an example of a table illustrating a comparison of a plurality of business objectives for an entity. A user may rank the objectives by marking the relationship between the objective with values of 1 or 0. For instance, 1 indicates that objective on the x-axis is more important than the objective on the y-axis and 0 indicates that that objective on the y-axis is more important than the objective on the x-axis. Then, the control unit 33 prioritizes the plurality of business objectives (at 230) by calculating a ranking value (i.e., ranking score) for each of the objectives based on the entered ranking for each of the business objectives. FIG. 6 shows an example of a table that illustrates prioritizing a plurality of business objectives by using a ranking score. In that example, the ranking or value score is calculated by adding all inputted valued for each business objective. The business objective with the lowest ranking value has the highest priority. In another example, alternative methods for comparing and prioritizing the business objectives may be used (i.e., methods that do not involve receiving a direct input from a user).

At 240, the control unit 33 identifies a plurality of business processes supporting the business objectives from the business processes data. The business processes may be manually entered or may be selected from a group of predetermined business processes available to the entity. Examples of business processes include: customer relationship management, supply chain management, operation/manufacturing management, research and development, business intelligence and strategy, finance and administration, corporate resource management, etc.

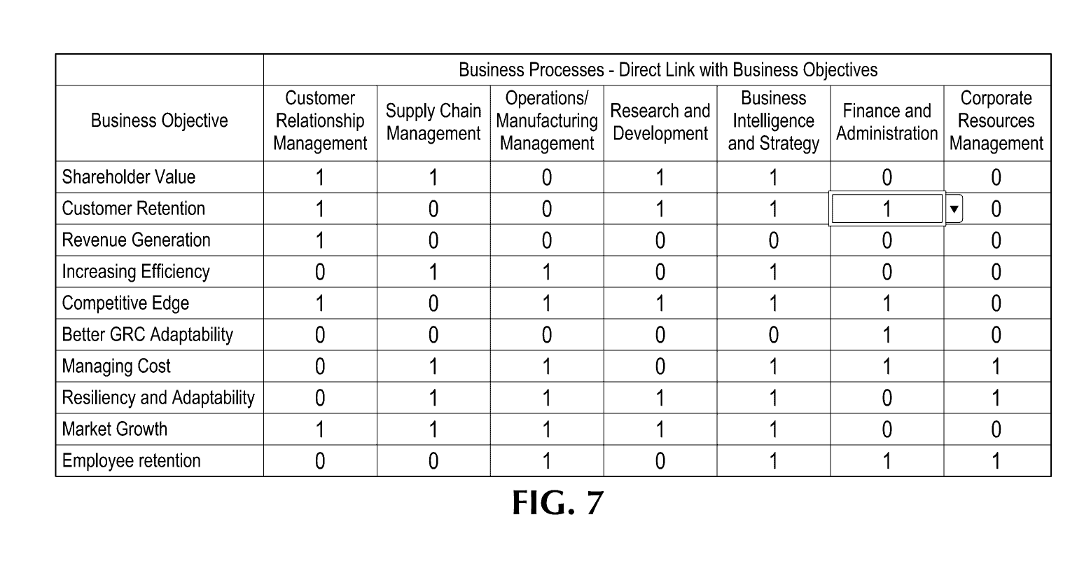

At 245, the control unit 33 receives input to assess each of the plurality of business processes in relation to the business objectives. Alternatively, assessing may be performed automatically without a direct input from a user. In other words, the control unit determines the relationship between the business processes and the business objectives. For example, the control unit 33 may generate a table that compares the plurality of business processes with the business objectives. FIG. 7 shows an example of a table illustrating a comparison between a plurality of business objectives and a plurality of business processes for an entity. As shown in FIG. 7, each business process is displayed in the x-axis and each business objective is displayed in the in y-axis of the table, and a user may enter values (e.g., 1 and 0 for each relationship). The control unit then links the plurality of business processes to the business objectives (at 250) based on the entered values, where 1 may represent a significant link between a business objective and a business process and 0 may represent slight or absent links between a business objective and a business process.

Next, at 255, the control unit 33 identifies a plurality of information assets supporting the business processes from the information assets data. The information assets may be manually entered or may be selected from a group of predetermined information assets available to the entity. Using techniques similar to the techniques described in relation to steps 245 and 250, the control unit then 33 receives input to assess each of the plurality of information assets in relation to the business processes (at 260) and links the plurality of information assets to the business processes. With the described processes the control unit 33 links or correlates the risk assessment data for the entity and defines relationships between the business objectives, business processes, and the information assets of the entity.

With continued reference to FIG. 4B, the control unit 33 identifies a plurality of incidents from the security incidents data (at 267). The incidents may be manually entered or may be selected from a group of predetermined incidents available to the entity. Using techniques similar to the techniques described in relation to steps 245 and 250, the control unit 33 receives input to assess each of the plurality of incidents in relation to the information assets (at 270) and links the plurality of incidents to the information assets (at 272). In other words, the significance of the identified incidents to the information assets of the entity is determined. That way, a correlation is created between the risk assessment data and the risk component data for the entity.

At 275, the control unit 33 identifies a plurality of security vulnerabilities from the security vulnerabilities data. Then, the control unit receives input to assess each of the plurality of security vulnerabilities in relation to the incidents (at 280) and links the plurality of security vulnerabilities to the incidents (at 282) (e.g., by using techniques similar to the techniques described in relation to steps 245 and 250). That way, the significance of vulnerabilities to the incidents is determined. At 285, the control unit 33 identifies a plurality of security threats from the security threats data. Then, the control unit 33 receives input to assess each of the plurality of security threats in relation to the security vulnerabilities (at 290) and links the plurality of security threats to the security vulnerabilities (at 295) to determine the significance of the threats to the vulnerabilities. This completes the linking process between threats, vulnerabilities, incidents, information assets, business processes, and business objectives.

Therefore, the proposed system 5 uses the described links between the risk assessment data and the risk component data for the entity to connect a change in the at least one security risk metric to the risk component data and ultimately to the risk assessment data. The system may identity potential or actual modifications in the risk assessment data associated with the risk component data based on the specific change in the at least one of the security risk metrics. That way, stakeholders of the system 5 may manage the information security risk in the entity more effectively. The different stakeholders in the entity can evaluate the information security risk for entity by understanding its potential effect on specific business objectives throughout the entity. With the established links between the risk component data and the entity's information assets, business processes, and business objectives, the system 5 can communicate security accidents and risk status in a relevant way to the different stakeholder groups.

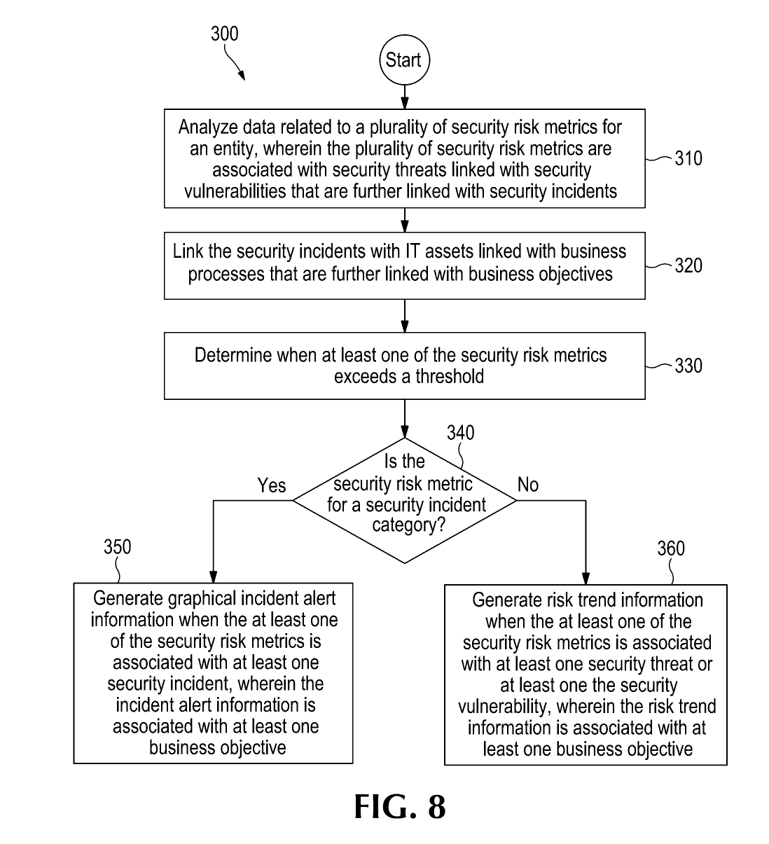

FIG. 8 illustrates a flow chart showing an example of an alternative method 300 for managing information security risk in an entity in accordance with an implementation of the present disclosure. In one example, the method 300 can be executed by the system 5 that includes the computing device 10. The method 300 may be executed with the security risk metrics module 39, the risk component data and risk assessment data module 40, and the display information generation module 41, where these modules are implemented with electronic circuitry used to carry out the functionality described below. Various elements or blocks described herein with respect to the method 300 are capable of being executed simultaneously, in parallel, or in an order that differs from the illustrated serial manner of execution.

The method 300 begins at 310, where the system 5 is to analyze data related to a plurality of security risk metrics for an entity. As noted above, the plurality of security risk metrics are associated with security threats linked with security vulnerabilities that are further linked with security incidents for the entity (described in steps 267-295 of method 200). That step is similar to step 110 of the method 100, where the data related to the plurality of security risk metrics may be collected or extracted from the entity's security technology and processes. This step may be performed by the security risk metrics module 39.

At 320, the system 5 links the security incidents with information assets that are linked with business processes that are further linked with business objectives for the entity. That process is similar to steps 210-265 of the method 200. In addition, the security incidents are linked to security vulnerabilities that are linked to security threats to the entity. As mentioned above, all these security elements of the risk component data for the entity are associated with a plurality of security risk metrics that represent the information security data for the entity.

Next, the system 5 determines when at least one of the security risk metrics exceeds a threshold (at 330). This process is similar to step 120 of the method 100. In other words, the system determines whether there is a change in at least one of the security risk metrics associated with the risk component data. This may be performed by the risk component data and risk assessment data module 40.

At 340, the system 5 identifies the type of risk component data that is affected by the change in the at least one security risk metric. For example, the system 5 determines if the security risk metric that exceeds its threshold is associated with a security incident category or not. A security incident is a single or a series of unwanted or unexpected information security events that have a significant probability of causing harm to at least one information asset. When, the system 5 determines that the security risk metric that exceeds its threshold is associated with a security incident category, the system 5 generates graphical incident alert information (at 350). The incident alert information is associated with at least one business objective for the entity. In other words, the generated incident alert information indicates an actual risk to the entity (i.e., a risk to the business processes and objective linked to the asset or assets affected by the incident).

On the other hand, when the system 5 determines that the security risk metric that exceeds its threshold is not associated a security incident category (i.e., it is associated with at least one security threat or at least one security vulnerability), the system 5 generates risk trend information. The risk trend information is associated with at least one business objective for the entity. In other words, the risk trend information indicates a potential risk to the entity and not an actual risk. Security threats can only cause harm to information assets if they are able to exploit a vulnerability (or vulnerabilities) linked with those assets via an actual security incident. Vulnerabilities can only cause harm to the information assets with which they are linked if there are threats which are able to exploit them. Thus, threats and vulnerabilities alone have only the potential to cause harm to the entity.

FIG. 9 shows an example of a graphical representation illustrating incident alert information and risk trends information for a plurality of business objectives. As shown in FIG. 9, the system 9 may display incident alert information and risk trends information for each of the plurality business objectives. In one example, the business objectives may be displayed in a prioritized order. The incident alert information (i.e., a visual indicator) shows information related to an incident associated with the specific business objective. For example, a check mark symbol may indicate that there is no issue with that business objective and the associated incidents; an exclamation point symbol may indicate an increased activity related to the metrics associated with the incident elements for that objective; an “x” symbol may indicate that the associated incident(s) exceed a threshold (i.e., information security event(s) will probability cause harm to at least one information asset related to the business objective).

The risk trend information indicates potential risk to the entity. That risk trend information (i.e., a visual indicator) may indicate the potential risk for the entity's business objective based on the levels of security threats or vulnerabilities linked to that business objective. In one example, the risk trend indicator may show that the risk trend for each business objective is increasing, decreasing, or remains the same. The displayed incident alert information and risk trend information may be updated on preset time intervals. That way, the system may continuously inform a stakeholder in the entity about the information security risk status of the entity and how it impacts specific business objectives.

The proposed system displays information about the risk assessment data and the risk component data for the specific entity. FIG. 10 shows an example of a graphical representation illustrating risk assessment data and the risk component data for an entity. As shown in FIG. 10, a user may click on a business objective to see the business processes linked to the business objectives. Each of the business processes may have an indicator (e.g., a color indicator, symbol indicator, etc.) that represents the risk of the information assets associated with that business process (e.g., green may indicate stable information assets, yellow may indicate some activity related to the information security of the information assets, red may indicate that there is an issue/risk related the information assets). The graphical representation may be expanded (e.g., by clicking on a component) to display information about information assets supporting the business processes, the security incidents linked to the information assets, the security vulnerabilities linked to the security incidents, and the security threats linked to the security vulnerabilities. All of the display components for the risk assessment data and the risk component data may include indicators (e.g., the indicator for the business processes represents the risk of the processes from the incidents linked to the processes, etc.).

That way, the system 5 overcomes the problem of communicating meaningful risk assessments to all stakeholders of the entity. By linking stakeholders' business objectives, processes, and assets to data (i.e., security risk metrics) gathered about threats, vulnerabilities and incidents, the system can display the created relationships to a stakeholder. All linkages can be re-assessed and edited at intervals determined by the stakeholders. Thus, the system 5 communicates information security data in a way that enables effective and efficient decisions to be made about the management of information security risk, as it affects the business objectives of different stakeholders though an entity.

What is claimed is:

1. A method, comprising:
processing data related to a plurality of security risk metrics for an entity;
identifying a change in at least one of the security risk metrics, wherein the security risk metrics are associated with risk component data;
determining modifications in risk assessment data that is associated with the risk component data based on the change in the at least one of the security risk metrics; and
displaying information about the risk assessment data and the risk component data.

2. The method of claim 1, wherein the risk assessment data includes business objectives data, business processes data, and information assets data, and wherein the risk component data includes security threats data, security vulnerabilities data, and security incidents data.

3. The method of claim 2, further comprising:
identifying a plurality of business objectives from the business objectives data;
comparing the plurality of business objectives; and
prioritizing the plurality of business objectives.

4. The method of claim 3, further comprising:
identifying a plurality of business processes supporting the business objectives from the business processes data;
assessing each of the plurality of business processes in relation to the business objectives; and
linking the plurality of business processes to the business objectives.

5. The method of claim 4, further comprising:
identifying a plurality of information assets supporting the business processes from the information assets data;
assessing each of the plurality of information assets in relation to the business processes; and
linking the plurality of information assets to the business processes.

6. The method of claim 5, further comprising:
identifying a plurality of incidents from the security incidents data;
assessing each of the plurality of incidents in relation to the information assets; and
linking the plurality of incidents to the information assets.

7. The method of claim 6, further comprising:
identifying a plurality of security vulnerabilities from the security vulnerabilities data;
assessing each of the plurality of security vulnerabilities in relation to the incidents; and
linking the plurality of security vulnerabilities to the incidents.

8. The method of claim 7, further comprising:
identifying a plurality of security threats from the security threats data;
assessing each of the plurality of security threats in relation to the security vulnerabilities; and
linking the plurality of security threats to the security vulnerabilities.

9. A system comprising:
a computing device having at least one processing device with a control unit to
analyze data related to a plurality of security risk metrics for an entity, wherein the plurality of security risk metrics are associated with security threats linked with security vulnerabilities that are further linked with security incidents;
link the security incidents with information assets linked with business processes that are further linked with business objectives;
determine when at least one of the security risk metrics exceeds a threshold;
generate graphical incident alert information when the at least one of the security risk metrics is associated with at least one security incident, wherein the incident alert information is associated with at least one business objective; and
generate risk trend information when the at least one of the security risk metrics is associated with at least one security threat or at least one the security vulnerability, wherein the risk trend information is associated with at least one business objective.

10. The system of claim 9, wherein the control unit is further to:
receive an input to compare the business objectives;
prioritize the business objectives;
receive an input to assess each of the business processes supporting the business objectives in relation to the business objectives; and
receive an input to assess each of the information assets supporting the business processes in relation to the business processes.

11. The system of claim 10, wherein the control unit is further to:
receive an input to assess each of the incidents in relation to the information assets;
receive an input to assess each of the security vulnerabilities in relation to the incidents; and
receive an input to assess each of the security threats in relation to the security vulnerabilities.

12. A non-transitory machine-readable storage medium encoded with instructions executable by at least one processing, the machine-readable storage medium comprising instructions to:
collect data related to a plurality of security risk metrics for an entity, wherein the data related to the plurality of security risk metrics is associated with risk component data;
associate the risk component data with risk assessment data for the entity;
analyze the data related to the plurality of security risk metrics to determine when at least one of the security risk metrics exceeds a threshold; and
provide information about corresponding changes in the risk assessment data based on the change in the at least one of the security risk metrics.

13. The non-transitory machine-readable storage medium of claim 12, wherein the risk assessment data includes a plurality of business objectives, a plurality of business processes, and a plurality of information assets, and wherein the risk component data includes a plurality of security threats, a plurality of security vulnerabilities, and a plurality of security incidents.

14. The non-transitory machine-readable storage medium of claim 13, further comprising instructions to:
compare the plurality of business objectives;
prioritize the plurality of business objectives;
assess each of the plurality of business processes supporting the plurality of business objectives in relation to the business objectives;
link the plurality of business processes to the business objectives;
assess each of the plurality of information assets supporting the plurality of business processes in relation to the business processes; and
link the plurality of information assets to the business processes.

15. The non-transitory machine-readable storage medium of claim 14, further comprising instructions to:
assess each of the plurality of incidents in relation to the plurality of information assets;
link the plurality of incidents to the information assets;
assess each of the plurality of security vulnerabilities in relation to the plurality of incidents;
link the plurality of vulnerabilities to the incidents;
assess each of the plurality of security threats in relation to the plurality of security vulnerabilities; and
link the plurality of security threats to the security vulnerabilities.
